(19) United States
(12) Patent Application Publication
(10) Pub. No.: US 2003/0170342 A1
(43) Pub. Date: Sep. 11, 2003

(54) Choline acids as feed additive in animal nutrition

(76) Inventors: Nico N. Raczek, Kelkheim (DE); Christoph Mollenkopf, Frankfurt (DE)

Correspondence Address: ProPat, L.L.C., 2912 Crosby Road, Charlotte, NC, 28211-2815, US

(21) Appl. No.: 10/383,948

(22) Filed: Mar. 7, 2003

(30) Foreign Application Priority Data
Mar. 11, 2002 (DE) 102 10 642.8
Mar. 15, 2002 (DE) 102 11 431.5

(51) Int. Cl. A01K 1/00

(52) U.S. Cl. 426/2

(57) ABSTRACT

The present invention relates to choline acids for use as performance enhancers in animal nutrition. The choline acids are synthesized from choline and an organic acid selected from the group consisting of sorbic acid, benzoic acid, propionic acid, formic acid and fumaric acid. In addition, the invention relates to the use of the choline acids alone in feeds or in a mixture with other feed additives for improving health.

The invention relates to a product which comprises choline acids and can be used alone in feeds or in a mixture with other feed additives for growth promotion in animal nutrition.

### BACKGROUND OF THE INVENTION

Growth promoters are ergotropic substances which, when added in small amounts to the feed, increase animal performance, especially the growth of young farm animals, and finally bring about favorable feed utilization. Growth-promoting products differ widely in their chemical nature, and generally have antibiotic activity. Antibiotics is a term applied to metabolic products of certain bacteria, fungi, and also some higher plants, which inhibit or prevent the growth of many microorganisms. Therefore, in animal nutrition, a nutritive use of antibiotics as growth promoters is described, in contrast to antibiotics which are administered for medical purposes. In the animal feeds sector, antibiotics are frequently used as growth promoters. The use of antibiotics in this sector is suspected to be responsible for hazards which are due to resistant bacteria which can also damage human health in the long term. Therefore, products which are of less concern for health must be sought for this application. Thus, in other sectors also, increasingly substances which are of physiological and epidemiological health concern, or else are damaging for the environment, for example antibiotics, substances releasing formaldehyde, halogenated substances and many others, for example in foods, feeds, petfood, cosmetics, food-contact articles, silage, pomace or other wastes from the food industry, are being replaced by less hazardous substances. The purpose of these substances is firstly directed toward maintaining the value of the actual product. Secondly, however, their sanitary state is also to be enhanced and/or improved keeping quality is to be achieved.

The use of choline and its salts such as choline chloride ((2-hydroxyethyl)trimethylammonium chloride, formula: C₅H₁₄NOCl, MW: 139.6 g/mol, (CAS-No. 67-48-1), sometimes also called vitamin B₄, in the animal feed industry is added to the feed as a vitamin. However, for choline the term “vitamin” is scarcely applicable in the original sense because of its function and high requirement. Choline, as a lipotropic substance, participates in fat metabolism and must therefore be fed at a higher rate (g/kg of feed) than the actual vitamins. Choline can be synthesized as a intermediate from excess methionine.

Choline has numerous functions in metabolism, inter alia it is a building block of phosphatidylcholine and of sphingomyelin, important components in biological membranes. In addition, choline acts as a methyl group donor and serves in the formation of acetyl choline (neurotransmitter function).

Choline effects, in particular, fat metabolism and membrane structure. An adequate choline supply has an economizing effect on the methionine supply. In addition, the choline requirement decreases with a high methionine supply.

A choline deficit can also cause health problems in animals and humans. Dramatic consequences in the case of choline deficit are known particularly in the case of poultry (fatty liver). In the case of poultry the enzyme capacity for the methylation reaction of ethanolamine to form choline is frequently insufficient to ensure a supply from the body's own synthesis. Therefore, adequate choline supply via the feed is of particular importance in the case of chickens. A further symptom of deficit is perosis in the case of growing poultry (detachment of the Achilles tendon after joint deformations). In other animals, for example piglets, defective positions of the hind extremities have been reported in the case of choline deficit (splayed stance).

The use of choline or choline chloride to increase efficiency in animal feeding has already been studied several times (Twibell, R. G. and Brown, P B., (2000). Dietary Choline Requirement of juvenile yellow perch. Journal of nutrition, 130, 95-99.; Bryant-T C; Rivera-J D; Galyean-M L; Duff-G C: Hallford-D M; Montgomery-T H, (1999). Effects of dietary level of ruminally protected choline on performance and carcass characteristics of finishing beef steers and on growth and serum metabolites in lambs. J. Animal Science 77, 2893-2903), where beneficial effects on weight gain and feed utilization have been found (RU-A 2131678). In the raising of young animals, beneficial effects have been displayed, for example on addition of 0.55 or 0.88 g/kg of feed when raising piglets (Anonymous (1990). Sows fed choline farrow more and stronger piglets. Pigs 6, 17 and 55).

Alternative sources of choline from soybean lecithin and defatted lecithins produced therefrom contain up to 23% phosphatidylcholine. However, when this natural choline source is used, no significantly improved performance parameters can be observed with pigs (Kuhn, M. et al. (1998). Utilization of crude soybean lecithin as a native choline source in feed rations of fattening pigs. Fett/Lipid 100, 78-84).

The use of choline chloride is very widespread in the feed industry as a vitamin additive. Unfortunately, in solutions, the choline chloride content must not exceed approximately 75%, since solutions stored at an outdoor temperature below approximately 10° C. crystallize out, which is accompanied by great disadvantages in processing, transport and storage.

WO 96/08168 and U.S. Pat. No. 6,022,566 describe the use of a specially encapsulated choline chloride for ruminants. Choline-containing compounds can be used for this, such as choline bitartrate, choline dihydrogen citrate, choline bicarbonate, tricholine citrate and the free base. In WO 98/37774, improved weight gains and feed efficiency were also obtained with ruminants using encapsulated choline or by injections, infusions or implants.

U.S. Pat. No. 4,147,776 describes various choline salicylates for stabilizing the color in pharmaceutical compositions of various dosage forms.

EP-A 0 158 120 describes a process for producing flowable choline chloride/silica powders; EP-A 0 494 418 describes a process for producing concentrated choline chloride on natural carriers for use in animal feed mixtures. Combinations of the two processes are also known (U.S. Pat. No. 4,820,532).

It is further known that organic acids can be used to preserve feeds. The principle of action is determined by the undissociated acid moiety. The best preservative action is therefore developed by these acids in the acid pH range.

Feeding experiments have been carried out on various species of animals using organic acids. These verify that various organic acids, such as citric acid, fumaric acid or formic acid, are able to beneficially effect the animal performance when they are admixed in the optimum dose, for example, to a piglet feed (Kirchgeβner, M.; Roth, F. X. (1991). Ergotrope Effekte durch nutritiven Einsatz von organischen Saüren [Ergotropic effects due to nutritional use of organic acids]. Zbl. Hyg. 191, 265-276.; Roth, F. X., Kirchgeβner, M. (1998). Organic acids as feed additives for young pigs: Nutritional and gastrointestinal effects. J. Anim. Feed Sci. 7, 25-33.). In addition, it has also been found that, for example, sorbic acid at high concentrations (1.8-2.4% sorbic acid, based on the feed) has nutritional activity for growing piglets (Kirchgeβner, M.; Roth, F. X.; Paulicks, B. R., (1995). Zur nutritiven Wirkung von Sorbinsaure in der Ferkelaufzucht [Nutritional action of sorbic acid when raising piglets]. J. Anim. Physiol. a. Anim. Nutr. 74, 235-242).

The above described feed additives are not yet optimum for a very wide variety of reasons. There still remains a requirement from the feed industry for a feed additive which comprises sufficient amounts of active choline and which can be stored and processed without problem. In addition, this additive should be able to be manufactured without great technical complexity. Furthermore, the keeping quality of feed and feed additives should be ensured over long periods, that is to say the feed additive should also ensure microbiological keeping quality. Finally, the feed additive should be a substitute for antibiotic growth promoters which does not lead to development of resistance in microorganisms which are human pathogens.

### BRIEF DESCRIPTIONS OF THE INVENTION

All of these objects are achieved by compounds of the formula:

choline⁺X⁻

where choline⁺ is the choline cation and where X⁻ is sorbate, benzoate, propionate, formate or fumarate anion.

X⁻ is preferably sorbate, propionate or formate.

These compounds are termed hereinafter choline acids.

### DETAILED DESCRIPTION OF THE INVENTION

The known choline salts of citric acid and tartaric acid demonstrate activity only in encapsulated form with ruminants and are therefore preferred to choline chloride for technological reasons. In the case of the inventive choline acids, surprisingly, not only is a growth-promoting property also found with other animal species which are biologically completely different, but, in addition, a good preservative action is also achieved. This is because, by adding small amounts of a choline-acid-containing preparation in piglet feeding, significant improvements in performance are obtained with respect to growth rate and feed utilization.

The inventive choline acids can be admixed as feed additive to the feed either directly or, for example, adsorbed to a carrier.

The choline acids are expediently prepared from a commercially available choline halide, for example choline chloride, and the corresponding acid in the presence of a strong base such as sodium hydroxide solution. Alternatively, they may be synthesized from the choline halide and a corresponding salt of the acid, such as an alkali metal salt or alkaline earth metal salt, with removal of the alkali metal halide of alkaline earth metal halide.

The inventive choline acids are distinguished by ease of handling. They can be prepared either as pure substance or in solution. The concentration in aqueous solution is here 40-80%, preferably 50-80%, particularly preferably 70-80%. Thus simple and effective application is possible directly onto the feed or the feed premixes.

If the choline acids are in solution, thickeners and gelling agents can also be added to this solution for improved processing. Thickeners and gelling agents include, for example: agar, guar gum, gum arabic, carob bean meal, pectins, tragacanth, xanthan gum and various celluloses; in addition, sorbitol, sorbitan esters and (glycerol polyethylene glycol) ricinoleate, tallow fatty esters and tamarind seed meals. Preferably, 1,2-propanediol alginate, particularly preferably 1,2-propanediol, glycerol and alginates are used.

Surprisingly, concentrated choline acid solutions can still be processed readily even at low temperatures. Thus, for example, a 77.5% strength choline sorbate solution is still liquid at −18° C. This solution may be sprayed onto solid feed without problem at 4° C. outdoor temperature and is readily processable. In microbiological studies, in addition, a good antimicrobial activity of a 75% strength choline sorbate solution was found. It was particularly surprising that a synergistic action was found, compared with the use of potassium sorbate and choline chloride.

If the choline acids are used in dissolved form, they can be added either directly to the feed or a premix, or else they can be applied as a solution of the substance to a carrier. Carriers which can be used are organic or inorganic natural or synthetic absorbent materials having a porous structure. These include, for example, diatomaceous earths, sand, clays such as kaolin, bentonite, flint, zeolites, insoluble metal oxides such as titanium oxide, aerosil, corundum, granite, quartz, in particular synthetic or natural amorphous precipitated silicas, calcium silicate, magnesium silicates such as talcum or sodium aluminum silicates, for example perlite (E 599), insoluble metal salts such as aluminum phosphate, activated carbon, nylon powder, rice meal, beet cossettes, extracted palm kernel meal, corn meal, cereal brand, extracted soybean meal, feather meal, fish meal, bonemeal and waste from the food industry, and mixtures of these materials.

As carriers, and for stabilizing the absorbed choline acid solutions, >0-25% by weight, preferably 2.5-17.5% by weight, and particularly preferably 5-15% by weight, of the abovementioned carrier materials are used alone or in combination, based on the resultant overall mass (carrier+choline acid solution). The choline acid solutions are, for this purpose, sprayed onto the carriers, added dropwise during mixing or sprinkled onto the carrier.

The choline acids or choline acid solutions or the corresponding carrier-immobilized choline acids/choline acid solutions (called choline acid preparations hereinafter) can be added directly to the animal feed, or else can be added to the actual feed in a mixture with other feed additives or via premixes.

Suitable animal feeds are, for example, green fodder, silage, dried green fodder, roots, tubers, fleshy fruits, grains and seeds, brewer's spent grains, pomace, brewer's yeast, distillation sludge, milling byproducts, byproducts from sugar and starch manufacture and oil production and various food wastes. Certain feed additives (for example antioxidants) or mixtures of various substances (for example mineral mixtures, vitamin mixtures) can be added to such feeds for improvement. Special feeds are also adapted for certain animal species and their stages of development. This is the case, for example, in cattle and piglet raising. In this case feeds are used for calves, milking cows, young bulls and stud bulls and piglet finishing and starter feeds and piglet growth feeds.

The choline acids can be added to the feed dry individually or in a mixture, added before further processing (for example extrusion) or added dispersed in a mixture. For this purpose, expediently choline acid concentrations of 0.15-40.0 g/kg (based on the feed), preferably 0.25-35.0 g/kg, are employed.

The choline acid preparation can be used as sole additive to animal feeds, for example for raising calves, suckling piglets, piglets, poultry, fish, horses or lambs, as growth feed or milk replacer feed, or else in feed for finishing poultry, pigs, ruminants, fish and other farm animals or for laying hens. It can also be used in a mixture with other feed additives for these animals. In the usage rate, the age and stage of development of the animals is of critical importance. Fundamentally, in the case of growing animals, higher doses are to be used than with fully grown animals or animals which are being finished.

To ensure significant nutritional activity, an addition of choline acid in the following amounts is also expedient:

Piglets: 0.25 g/kg-27.5 g/kg of feed, preferably 0.5 g/kg-17.5 g/kg of feed. Marked improvements in performance with respect to growth rate and feed utilization have also been found when choline acids, in particular choline sorbate, are used in poultry rearing. In this case, in the case of chickens, 0.25 g/kg-25 g/kg of feed are added, preferably 0.5 g/kg-15 g/kg of feed. In the finishing and rearing of turkeys, 0.8-35 g/kg of feed are added to the feed, preferably 1.55 g/kg-22.5 g/kg of feed. To the feed of laying hens, 0.25 g/kg-25 g/kg of feed are added, preferably 0.5 g/kg-12.5 g/kg of feed.

Since nutritional activity has also been found in the case of adult animals, addition of choline acids is expedient in the following amounts: finishing pigs 0.1 g/kg-7.5 g/kg of feed, preferably 0.2 g g/kg-5.0 g/kg of feed, and pregnant sows 0.20 g/kg-25 g/kg of feed, preferably 0.25 g/kg=15 g/kg of feed.

The invention will be described in more detail below with reference to examples.

### EXAMPLE 1

Preparation of Choline Sorbate:

100 g (0.537 mol) of 75% strength choline chloride solution are charged. To this are added 86 g of potassium sorbate in 86 g of water. A light precipitate forms. At 50° C. and 30 mbar, the water is removed from the reaction mixture by distillation. The waxy residue is taken up in 100 ml of ethanol. The reaction mixture partially dissolves. The potassium chloride formed precipitates out and is filtered off. The ethanol is removed from the mother liquor by distillation. A waxy precipitate is again obtained, which is again taken up with 100 ml of ethanol. A precipitate again forms, which is also removed by filtration. After the ethanol has been removed in a rotary evaporator under reduced pressure, 121 g of choline sorbate are obtained as a waxy residue.

### EXAMPLE 2

To prepare a 50% strength choline sorbate solution, 121 g of water are added to the batch mentioned in example 1. A clear choline sorbate solution is obtained. The resultant solution can then be sprayed directly onto feed or onto a premix or be mixed in.

### EXAMPLE 3

The choline sorbate on a carrier material is prepared by slowly adding dropwise the choline sorbate solution produced in example 2 to perlite with simultaneous mechanical mixing using a tumble mixer. For this purpose 10 kg of perlite are placed in the mixer and 60 kg of the choline sorbate solution are added in portions in 5 kg steps.

### EXAMPLE 4

Preparation of Choline Propionate

100 g (0.537 mol) of choline chloride 75% are charged. To this are added 40 g of propionic acid. 21.5 g of sodium hydroxide are added to the solution with cooling. At 50° C. and 30 mbar, the water is removed from the reaction mixture by distillation. The waxy residue is taken up in 100 ml of ethanol. The reaction mixture partially dissolves. The sodium chloride formed precipitates out and is filtered off. The ethanol is removed from the mother liquor by distillation. A waxy precipitate is again obtained, which is again taken up with 100 ml of ethanol. A precipitate again forms, which is also removed by filtration. After the ethanol has been removed in a rotary evaporator under reduced pressure, 95 g of choline propionate are obtained.

### EXAMPLE 5

Preparation of Choline Benzoate

100 g (0.537 mol) of choline chloride 75% are charged. To this are added 77.4 g of sodium benzoate. At 50° C. and 30 mbar, the water is removed from the reaction mixture by distillation. The waxy residue is taken up in 100 ml of ethanol. The reaction mixture partly dissolves. The sodium chloride formed precipitates out and is filtered off. The ethanol is removed from the mother liquor by distillation. A waxy precipitate is again obtained, which again is taken up with 100 ml of ethanol. A precipitate again forms, which is also removed by filtration. After the ethanol has been removed in a rotary evaporator under reduced pressure, 120 g of choline benzoate are obtained as residue.

### EXAMPLE 6

Preparation of Choline Formate

The preparation is performed in a similar manner to example 4.100 g (0.537 mol) of choline chloride 75% are charged. To this are added 25 g of formic acid. 21.5 g of sodium hydroxide are added to the solution with cooling. Further workup is performed as described in example 4.80 g of choline formate are obtained.

### EXAMPLE 7

Preparation of Sodium Choline Fumarate

The preparation is performed in a similar manner to example 1.100 g (0.537 mol) of choline chloride 75% are charged. To this are added 86 g of disodium fumarate. Further workup is performed as described in example 1.120 g of sodium choline fumarate are obtained.

### EXAMPLE 8

A choline sorbate solution (50% strength) is sprayed continuously onto a piglet feed of the composition below (data in %), so that mean contents of 2 g of choline sorbate/kg are achieved.

Piglet feed, consisting of (data in %)

| | |
|---|---|
| Extracted soybean meal | 22.00 |
| Barley | 40.00 |
| Wheat | 31.00 |
| Vegetable oil | 2.90 |
| L-Lysine-HCl | 0.40 |
| DL-Methionine | 0.10 |
| L-Threonine | 0.10 |
| Mineral feed | 3.50 |

### EXAMPLE 9

A choline formate solution (50% strength) is sprayed on continuously to a piglet feed of the composition specified below, so that contents of 2.2 g of choline formate/kg of feed are achieved.

Piglet feed consisting of (data in %)

| | |
|---|---|
| Fish meal | 4.00 |
| Extracted soybean meal | 18.50 |
| Barley | 40.00 |
| Wheat | 33.00 |
| Vegetable oil | 1.90 |
| L-Lysine-HCl | 0.2 |
| DL-Methionine | 0.1 |
| L-Threonine | 0.1 |
| Mineral feed | 2.2 |

Microbiological Activity

In microbiological studies, in addition, good antimicrobial activity of a 75% strength choline sorbate solution was found. It was particularly surprising that a synergistic action was found compared with the use of potassium sorbate and choline chloride.

In the experiments, various molds were cultured under optimum growth conditions and, in a standardized agar well test (inhibitor test), the inhibition of the microorganisms specified in table 1 was tested. For this, the same concentrations of active substance and aqueous 1:1 dilutions prepared therefrom were each used in duplicate. The figures relate to the total inhibition zone size in mm. Transition zones occurred only to a slight extent and were not taken into account.

TABLE 1
Inhibition zone size in mm in use against some feed spoilage
organisms, due to choline sorbate solution 75%, 1:1
mixture of aqueous choline solution 39% and aqueous
potassium sorbate solution 48%, aqueous choline solution 39%,
aqueous potassium sorbate solution 48%.

| | | | | | 1:1 Mixture of | | | | | | | | | | | |
|---|---|---|---|---|---|---|---|---|---|---|---|---|---|---|---|---|
| | | | | | choline | | | | | | | | Potassium | | | |
| | Choline sorbate | | | | potassium | | | | Choline solution | | | | sorbate solution | | | |
| | 75% | | | | sorbate | | | | 39% | | | | 48% | | | |
| | | | 1:1 | | | | 1:1 | | | | 1:1 | | | | 1:1 | |
| Strain | undiluted | | diluted | | undiluted | | diluted | | undiluted | | diluted | | undiluted | | diluted | |
| Penicillium | 12 | 10 | 8 | 9 | 8 | 7 | 3 | 3 | 12 | 10 | 6 | 6 | 20 | 19 | 10 | 2 |
| commune | | | | | | | | | | | | | | | | |
| Penicillium | 20 | 20*) | 19 | 20 | 5 | 6 | 3 | 2 | 7 | 6 | 4 | 4 | 20 | 20*) | 20 | 20 |
| crysogenurn | | | | | | | | | | | | | | | | |
| Fusarium | 20 | 20*) | 20 | 20*) | 1 | 1 | 0 | 0 | 5 | 5 | 2 | 1 | 20 | 20*) | 20 | 20 |
| solani | | | | | | | | | | | | | | | | |
| Fusarium | 16 | 17 | 11 | 13 | 2 | 2 | 1 | 2 | 9 | 8 | 3 | 4 | 18 | 5 | 6 | 5 |
| oxysporum | | | | | | | | | | | | | | | | |
| Mucor | 20 | 20*) | 18 | 17 | 7 | 7 | 3 | 4 | 19 | 19 | 2 | 4 | 20 | 20*) | 20 | 20 |
| racemosus | | | | | | | | | | | | | | | | |
| Candida | 9 | 9 | 5 | 6 | 5 | 6 | 3 | 2 | 15 | 15 | 10 | 10 | 12 | 5 | 5 | 5 |
| albicans | | | | | | | | | | | | | | | | |

*)= growth completely inhibited

The results obtained verify impressively the excellent activity of choline sorbate compared with the simple mixture.

Performance Improvement

To study the performance-improving activity of the inventive preparations, feed experiments were carried out using in each case 9 weaned piglets (10 animals in group 1) raised individually. The feed of the three experimental groups was composed isoenergetically and was presented to the animals for ad lib uptake. In order to exclude effects of origin, sex or live weight, the treatments were assigned to animals chosen at random.

The addition of choline sorbate was made in a protein and energy equivalent manner, by removing the addition of corn starch and water from the mixtures in equivalent to the addition of choline sorbate in a ratio of 1:1. Table 2 shows the composition of the feed mixes used. These are feed mixes customary in practice having high contents of cereal, extracted soybean meal and low contents of fish meal and soybean oil. They correspond to the standard for a complete feed for piglets containing about 19% crude protein, 1.14% lysine and 13.2 MJ of convertible energy/kg of feed (table 3).

TABLE 2
Composition of the feed mixes used (%)

| Group | I | II | III |
|---|---|---|---|
| Wheat | 40.00 | 40.00 | 40.00 |
| Barley | 25.55 | 25.55 | 25.55 |
| Extracted soybean meal | 21.05 | 21.05 | 21.05 |
| Fish meal | 5.00 | 5.00 | 5.00 |
| Soybean oil | 1.95 | 1.95 | 1.95 |
| Mineral feed | 2.45 | 2.45 | 2.45 |
| Corn starch | 2.00 | 1.90 | 1.00 |
| Water | 2.00 | 1.90 | 1.00 |
| Choline sorbate (50% strength) | — | 0.20 | 2.00 |

TABLE 3
Nutrient contents in the base feed (g/kg)

| | |
|---|---|
| Dry mass | 864 |
| Crude protein | 190 |
| Crude ash | 53 |
| Crude fat | 36 |
| Crude fiber | 36 |
| N-free extract | 548 |
| Convertible energy (MJ/kg) | 13.2 |
| Calcium | 8.5 |
| Phosphorus | 6.4 |
| Lysine | 11.4 |
| Methionine | 3.6 |
| Methionine + cystine | 6.8 |
| Threonine | 7.3 |
| Tryptophan | 2.4 |

The feed mixtures were presented to the animals in pelleted form for ad lib uptake. The feed was presented daily, the unconsumed feed was reweighed twice a week. Drinking water was always available via automatic dispensers. As experimental criteria, the weight gain (growth rate per day), feed consumption and feed utilization (feed uptake per g of growth) were determined.

Based on the content of choline sorbate, concentrations of 0 (no addition), 0.1 and 1.0% were added to the overall animal feed. Surprisingly, this addition to the feed, even at the low concentration, showed a marked effect with respect to growth in the piglets. Additions increased the growth rates in each case by approximately 3%/day. In addition, the feed consumption, which is of particular economic importance, was markedly decreased in the highest dose rate compared with group 1. The feed utilization was also improved overall after choline sorbate addition, with the most favorable results being achieved at a dose rate of 1.0%. The results of this study are summarized in table 4.

TABLE 4
Effect of choline sorbate additions on live weights,
growth rate, feed consumption and feed utilization in piglets

| Group | | I | II | III |
|---|---|---|---|---|
| Choline sorbate addition, % | | 0 | 0.1 | 1.0 |
| Initial weight, kg | | 10.01 ± | 10.02 ± | 10.05 ± |
| | | 1.49 | 1.14 | 1.31 |
| Final weight, kg | | 30.86 ± | 31.58 ± | 31.51 ± |
| | | 3.78 | 3.02 | 2.53 |
| | relative | 100 | 102.3 | 102.1 |
| Growth rate, g/d | | 596 ± | 616 ± | 613 ± |
| | | 76 | 65 | 44 |
| | relative | 100 | 103.4 | 102.9 |
| Feed consumption, g/d | | 925 ± | 957 ± | 899 ± |
| | | 116 | 84 | 66 |
| | relative | 100 | 103.5 | 97.2 |
| Feed consumption- | | 1.55 ± | 1.56 ± | 1.47 ± |
| per g of growth, g | | 0.06 | 0.09 | 0.10 |
| | relative | 100 | 100.6 | 94.8 |

1. A compound of the formula:
choline⁺X⁻
where choline⁺is the choline cation and X is a sorbate, benzoate, propionate, formate or fumarate anion.

2. The compound as claimed in claim 1, wherein X is a sorbate, propionate or formate anion.

3. A process for preparing a compound as claimed in claim 1, which comprises reacting a choline halide with an acid selected from the group consisting of sorbic acid, benzoic acid, propionic acid, formic acid and fumaric acid or a salt of one of these acids, in the presence or absence of a base, and then, if appropriate, removing the halide which has formed of the base and then isolating the choline compound.

4. A method of making a feed additive or feed premix which method comprises converting a compound as claimed in claim 1 into a feed additive or adding a compound as claimed in claim 1 to a feed premix.

5. The method as claimed in claim 4 wherein the feed additive or feed premix is for pig rearing and finishing.

6. The method as claimed in claim 4 wherein the feed additive or feed premix is for rearing breeding sows.

7. The method as claimed in claim 4 wherein the feed additive or feed premix is for cattle rearing and finishing.

8. The method as claimed in claim 4 wherein the feed additive or feed premix is for lamb rearing and finishing.

9. The method as claimed in claim 4 wherein the feed additive or feed premix is for sheep rearing and finishing.

10. The method as claimed in claim 4 wherein the feed additive or feed premix is for rearing chickens.

11. The method as claimed in claim 4 wherein the feed additive or feed premix is for rearing laying hens.

12. The method as claimed in claim 4 wherein the feed additive or feed premix is for rearing turkeys.

13. The method as claimed in claim 4 wherein the feed additive or feed premix is for rearing and maintaining edible fish.

14. The method as claimed in claim 4 wherein the feed additive or feed premix is for rearing and maintaining shrimps (Crangon sp.).

15. The method as claimed in claim 4 wherein the feed additive or feed premix is for rearing and maintaining pets.

16. The method as claimed in claim 15, wherein the feed additive or feed premix is for rearing and maintaining dogs, cats, birds, aquarium fish and small rodents.

17. A preparation comprising a carrier and at least one compound as claimed in claim 1 applied to the carrier.

18. The preparation as claimed in claim 17, which comprises >0 to about 25% by weight of carrier.

19. The preparation as claimed in claim 17 or 18, wherein the carrier is selected from the group consisting of organic materials, inorganic materials, natural materials, and synthetic materials, wherein these materials have a porous structure.

20. A feed which comprises a compound as claimed in claim 1.

21. A feed as claimed in claim 20, which comprises about 0.15-about 40 g/kg (based on the feed) of the compound.

22. The feed as claimed in claim 20 or 21, which comprises a preparation as claimed in one of claims 17 to 19.

23. A feed additive which comprises a compound as claimed in claim 1.

24. The feed additive as claimed in claim 23, which comprises a preparation as claimed in one of claims 17 to 19.
